(19) United States
(12) Patent Application Publication
(10) Pub. No.: US 2023/0410156 A1
(43) Pub. Date: Dec. 21, 2023

(54) INCREASING USER ENGAGEMENT THROUGH AUTOMATIC FEEDBACK OF INCENTIVIZED USER TASK COMPLETION

(71) Applicant: Microsoft Technology Licensing, LLC, Redmond, WA (US)

(72) Inventors: Marcelo M. DE BARROS, Redmond, WA (US); Manish MITTAL, Woodinville, WA (US); Vinod Krishnan KODUVAYOOR SUBRAMANIAN, Sammamish, WA (US); Prateek TIWARI, Sammamish, WA (US)

(73) Assignee: Microsoft Technology Licensing, LLC, Redmond, WA (US)

(21) Appl. No.: 17/843,711

(22) Filed: Jun. 17, 2022

(51) Int. Cl. G06Q 30/02

(52) U.S. Cl. CPC G06Q 30/0271; G06Q 30/0209; G06Q 30/0253; G06Q 30/0277

(57) ABSTRACT

Aspects of the present disclosure relate to systems and methods for increasing user engagement using incentivized user task completion. In some embodiments, the incentivized user tasks relate to game related tasks in exchange for rewards, also referred to as “gamification”. Such gamification techniques entice user interaction by involving introducing user specific games, rewards, and prizes into the online shopping experience. As described herein, such functionality relates to identifying user specific features, identifying a list of prized products for the user, introducing games for the user to engage with, and rewarding the user for successfully completing a game. The games and rewards may be presented to the user in an interactive visual display incorporating the game modules and rewards throughout. The gamification process may be a collaborative endeavor between the online shopping platform and online sellers to develop games and rewards which market products directly to specific users.

### BACKGROUND

Understanding user engagement with websites improves many aspects of the computer system itself, through analysis of user behavior and making modifications to the systems to improve the user experience. That said however, user engagement wanes over time such that many systems fail to attain any benefit from understanding user behavior. Indeed, systems are designed to achieve and complete desired user tasks so the user may move on to other tasks. Unfortunately, systems are not improved without receiving a true understanding of the underlying user behavior.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to systems and methods for increasing user engagement using incentivized user task completion. In some embodiments, the incentivized user tasks relate to game related tasks in exchange for rewards, also referred to as “gamification”. Such gamification techniques entice user interaction by involving introducing user specific games, rewards, and prizes into the online shopping experience. As described herein, such functionality relates to identifying user specific features, identifying a list of prized products for the user, introducing games for the user to engage with, and rewarding the user for successfully completing a game. The games and rewards may be presented to the user in an interactive visual display incorporating the game modules and rewards throughout. The gamification process may be a collaborative endeavor between the online shopping platform and online sellers to develop games and rewards which market products directly to specific users. Games and rewards may be offered to increase user engagement with the online shopping feed.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 illustrates an exemplary environment for providing an online shopping feed with games and rewards, according to aspects described herein.

FIG. 2 illustrates an exemplary online shopping feed with games and rewards, according to aspects described herein.

FIG. 3 is a diagram illustrating a system for providing a shopping feed with games and rewards, according to aspects described herein.

FIG. 4 is a block diagram illustrating a method for presenting a shopping feed with games and rewards for user interaction, according to aspects described herein.

FIG. 5 is a block diagram illustrating a method for generating a user specific game and reward, according to aspects described herein.

FIG. 6 is a block diagram illustrating example physical components of a computing device with which aspects of the disclosure may be practiced.

FIG. 7 are simplified block diagrams of a mobile computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations, specific embodiments or examples. Aspects of the descriptions, drawings, etc. may be combined, while other aspects may be utilized, and structural changes may be made without departing from the present disclosure. Embodiments may be practiced as methods, systems or devices. Accordingly, embodiments may take the form of a hardware implementation, a software implementation, or an implementation combining software and hardware aspects. The following detailed description is therefore not to be taken in a limiting sense, and the scope of the present disclosure is defined by the appended claims and their equivalents.

Many websites could benefit from increased user engagement. For instance, websites offering online shopping platforms with shopping feeds which offer consumers access to a variety of goods and services at competitive prices which otherwise might not be available in their location could benefit from understanding which products to display and make available to users. Providing more attractive goods and services will reduce the time it takes for future users to identify and purchase products and services. That said however, current systems do not incentivize users to engage with the website in such a way as to glean more information about the products and services provided. Ultimately, such deficiencies may encourage users to ignore the shopping feed and search for specific products directly which leads to decreased user interaction and exploration of the online shopping platform.

Exemplary embodiments, as described herein, help resolve these deficiencies through automatic feedback to users in response to specific and incentivized task completion. In some cases, the present technology relates to online shopping platforms that offer a shopping feed to consumers, wherein the feed highlights the diversity of goods and services available on the platform. The shopping feed is interactive in that users receive information, e.g., recommendations for new items, and the user can complete certain tasks, such as browsing general categories, and selecting specific goods and services to research and/or purchase, among other tasks.

To address these issues, embodiments described herein introduce gamification of the shopping feed where a user-specific game may be presented to the user with associated rewards for successfully accomplishing game tasks. Games may be specifically for the user based on personalization features and user interaction data which may be identified for each user, seller, and/or shopping feed preferences in addition to other sales factors. The personalization features may be applied singularly or in combination to encourage user engagement with the shopping feed. The games may be presented to the user on the shopping feed visual display that incorporates the aspects of the traditional shopping feed with the games and rewards. Game playing is further incentivized by rewards that may include both extrinsic and intrinsic rewards as motivation to engage with the offered game. Gamification increases user engagement by creating an exciting rewards-based interactive element that is specific to each individual user, i.e., automatically providing feedback to the user based on task completion. Consequently, the total volume of users on the shopping feed as well as the frequency and duration of user dwell time will increase. Additionally, such automatic analysis and feedback, i.e., gamification, may incentivize users from an alternative entry point (e.g., other webpages, applications, and/or platforms) to enter the shopping feed and participate in the game. Gamification also benefits sellers utilizing the shopping feed by increasing the total volume of users reached as well as creating an additional marketing strategy to highlight seller products.

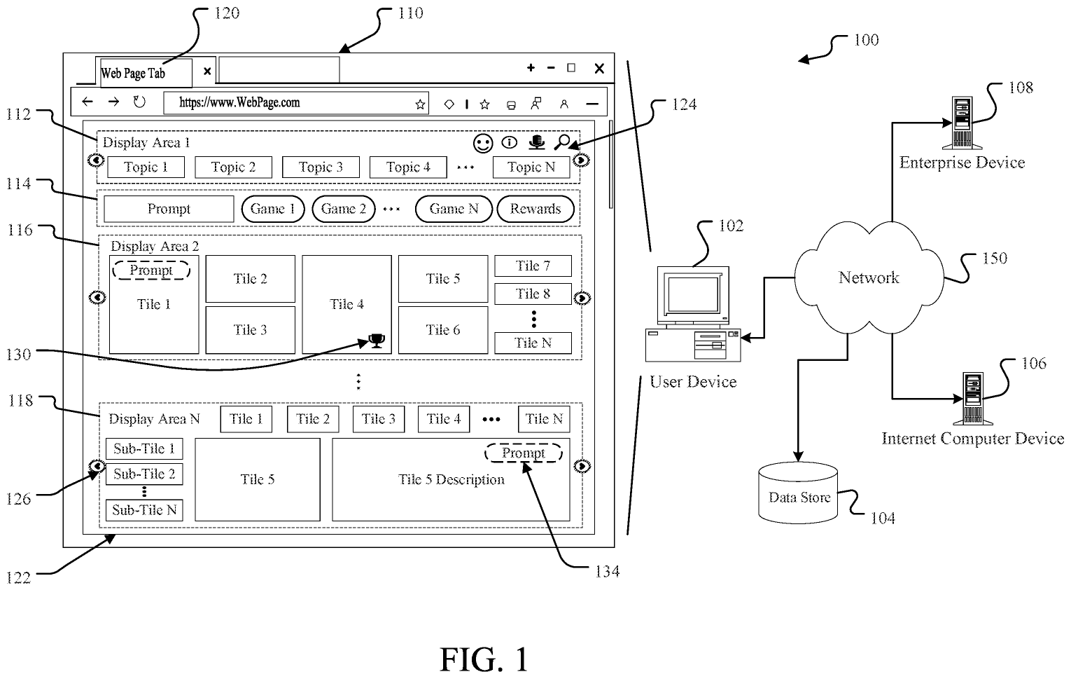

FIG. 1 illustrates an exemplary environment for providing a website, in this example an online shopping feed, that provides automatic feedback, through the presentation of games and the providing of rewards, according to aspects described herein. As illustrated, environment 100 comprises a user device 102, data store 104, internet computer device 106, enterprise device 108, network 150, visual display 110, web page tab 120, shopping feed 122, a gamification module, and a plurality of display areas 112, 116, and 118. The environment 100 may have a user device 102, which communicates over network 150 with an enterprise device 108. A visual display 110, displayed on user device 102, may contain web page 120 with a shopping feed 122, gamification module 114, and a plurality of display areas 112, 116, and 118 to facilitate product presentation with gamification to the user.

In a typical use scenario, a user may access a visual display 110 within a web page tab 120 on a user device 102 to interact with a shopping feed 122. The shopping feed 122 may include a gamification module 114 which may present a prompt, a game option, and/or a reward to the user to interact with. The prompt, game option, and/or reward as well as any products incorporated into the gamification may be specific to the user based on personalization features to maximize the likelihood of user engagement. The user may choose to participate in a game on the shopping feed for a certain reward. Upon the completion of a task associated with the game the user may receive the reward. The reward may be automatically applied to the user's account on the shopping feed 122 and/or the user may take some additional action to claim and/or utilize the reward.

The enterprise device 108 may communicate with other Internet computer devices 106 to help satisfy a request from shopping feed 122 on the user device 102. Additionally, in accordance with some embodiments, the user device 102 may have access to data in data store 104. The data store 104 may contain information about the user, sellers, product information, enterprise data, game information, rewards information, etc. which may be useful in populating the shopping feed 122 with information, games, and rewards. In some instances, there may be search and suggestion functionality included with the presentation of the visual display 110. The use of search and suggestion functionality may involve a search of data store 104 over a network, such as network 150 or a separate, proprietary network. Accordingly, content from data store 104 may be presented in visual display 110 and/or shopping feed 122.

The user may access the shopping feed 122 through a web page tab 120. The shopping feed 122 may include one or more display areas, such as display areas 112, 116, and 118 as well as one or more gamification modules, such as gamification module 114. The gamification module 114 may present a variety of information to the user to encourage the user to engage with the shopping feed 122. The information presented may be in the form of a prompt via a prompt banner, one or more game tiles, and one or more rewards tiles. Each of the prompt banner, game tile, and/or rewards tile may be interactive and/or selectable by the user. Selection of a tile may present more information to the user, transition the user to a different web page, and/or a different portion of the shopping feed 122. Alternatively, selection of a tile may result in a pop-up window on the visual display 110 which may present information to the user. A prompt, such as exemplary “Prompt”, may include messages or information to the user conveying options for interaction with the shopping feed. A game tile, such as exemplary “Game 1” “Game 2” to “Game N”, may present game options to the user as an opportunity to perform a task with an associated reward. A rewards tile, such as exemplary “Rewards”, may provide rewards status information to the user. In some embodiments the rewards tab may include options to redeem rewards on the shopping feed.

A display area may contain information pertaining to the shopping feed that may also incorporate aspects of a game or rewards. When the user accesses the shopping feed they may see items of interests presented within the display area, such as topics in display area 112 or tiles and sub-tiles within display areas 116 and 118. This information may pertain to general categories or specific products, goods, and/or services that are available for review and purchase on the shopping feed. The information presented as tiles and/or topics in the display area, such as display areas 112, 116, and 118, may be interactive and selectable such that the user may click on or otherwise interact with the tile and/or topic to view more information or open a separate webpage. Alternatively, selection of a tile and/or topic may result in a pop-up window on the visual display 110 which may present information to the user. In some instances, such as in display area 112, there may be symbol icons 124 which provide a visual indication of other actions available on the shopping feed. In this instance, the symbol icons include a user image linking to the user profile, information circle, microphone for voice enabled commands, and a search magnifying glass to access a search function. Additional symbol icons may include a help icon, image tab, links to other web sites or social media sites, options to move to a different topic or portion of the shopping feed, payment options, etc. In other instances, a display area and/or gamification module may include a scroll icon, such as scroll icon 126 on display area 118. The scroll icon 126 may enable the user to scroll through various tiles, topics, or other information presented in the display area or gamification module when selected.

In some instances, the gamification engine may populate tiles and/or topics in a display area with prompts including badges, gaming indicators, hints, and/or other indicators to the user that the tile or topic is part of a game or reward. For example, prompt 134 may be a hint, a discount, sale indicator, or some other indication to the user that “Tile 5 Description” in display area 118 is part of a game that the user may choose to participate in. Similarly, the prized product indicator 130 may indicate to the user that tile 4 in display area 116 is a prized product or carries some game or reward element which the user may interact with. The prompts may be present throughout the shopping feed 122 based on the games and rewards generated by the gamification engine for the specific user.

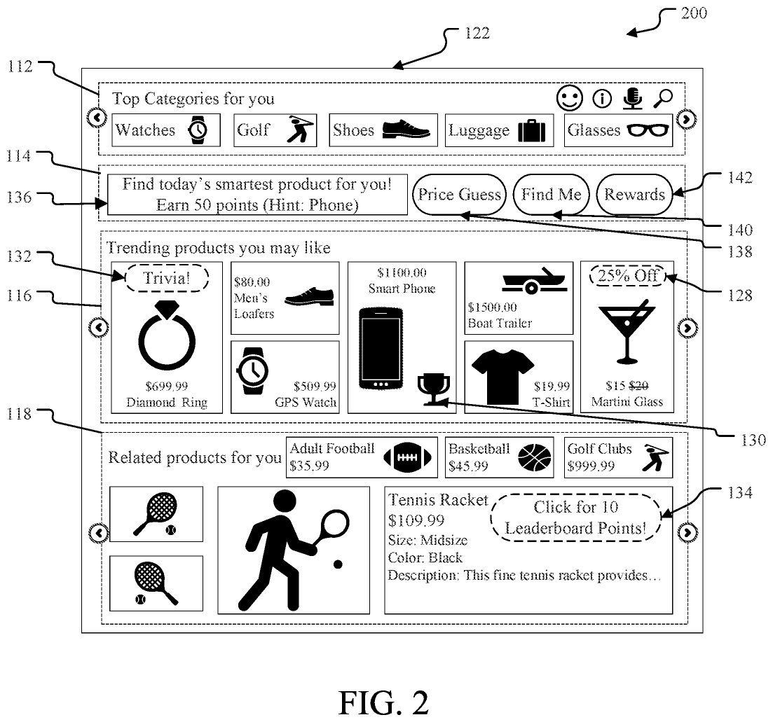

FIG. 2 illustrates an exemplary online shopping feed with games and rewards, according to aspects described herein. Upon accessing the shopping feed 122, the user may be presented with one or more display areas, such as display areas 112, 116, and 118, and/or one or more gamification modules, such as gamification module 114, which may be specific to the user. The personalization may include selecting one or more games from a plurality of game types to match user interests and/or preferences then selecting one or more user specific products to utilize in the selected one or more games which match user interests and/or preferences. The personalization may be applied throughout the shopping feed 122, in both the display areas 112, 116, 118 and gamification module 114. A product may include a good, service, and/or other article or substance that is manufactured, refined, processed, and/or offered for sale.

A display area, such as display areas 112, 114, and 116, may be an area within the shopping feed 122 where information pertaining to products offered on the shopping feed 122 are presented to the user. A display area may include a label, such as “Trending products you may like” in display area 116 and “Related products for you” in display area 118. Within the display area, information may be presented to the user with tiles, topics, categories, symbols, and/or icons. The information may include text, images, videos, links, etc. about the products offered for sale on the shopping feed. As will be appreciated by one skilled in the art, the visual display 110, shopping feed 122, gamification module 114, display areas 112, 116, and 118 may use a variety of color schemes, alignments, orientations, and/or designs to highlight each aspect and increase user engagement

The gamification module 114 may present a variety of information to the user to encourage the user to engage with the shopping feed 122. The information may be presented in a variety of formats specific to the user. Presentation formats may include a prompt window, hints, game tiles, rewards tiles, leaderboards, user standing among other users participating within a game, links, reward status, game progress status, timers, time remaining in a game, time remaining to participate a game, time remaining to utilize a reward, links to other webpages or popup windows, or other formats of presenting information. The information presented in the gamification module 114 may be interactive and/or selectable by the user. In this instance, gamification module 114 contains a prompt window 136, game tile 138, game tile 140, and rewards tile 142.

Prompt window 136 may include messages or information to the user conveying options for interaction with the shopping feed. For example, a prompt may inform the user of a new game available in the gamification module 114, previous game status, available games, a link to a complete list of games, updated rewards totals, available rewards, hints to perform a game task, messages that celebrate completing a game task, messages recommending a product or task, and/or other information encouraging user interaction with the shopping feed. In this instance the prompt window includes a prompt “Find today's smartest product for you!” which is both a recommendation to browse the shopping feed 122 as well as an invitation to participate in a find me game. Additional information, “Earn 50 points” is presented in the prompt window 136 to inform the user how many rewards they will earn for completing the find me game. Also, prompt window 136 includes a hint “(Hint: Phone)” which is further encouragement to participate and ties to the initial prompt “smartest” and “phone” with the smartest product being the “Smart Phone” tile in display area 116. Alternatively, prompts may be presented to the user outside the gamification module 114, with pop-up banners, alerts on a computing and/or mobile device, alerts on an application, banners scrolling on the shopping feed 122, prompts placed on tiles and/or topics on the shopping feed 122, and/or a variety of other methods designed to notify the user that games and/or rewards are available to interact with. For example, a “Trivia!” prompt 132 is presented in display area 116 to prompt the user that a trivia game and reward are associated with the “Diamond Ring” product. Similarly, a “Click for 10 Leaderboard Points!” prompt 134 is displayed on the “Tennis Racket” tile in display area 118, to alert the user that clicking the prompt 134 and/or the “Tennis Racket” tile may earn the user 10 points for the leaderboard rankings.

The gamification module 114 may also include one or more game tiles, such as exemplary game tiles 138 and 140. The game tiles may present game options to the user as an opportunity to participate in specific predetermined games. Each game may include an associated reward for participation and/or completing a task within the game, but the game does not need to include a reward to be presented to the user. A game presented to the user may be a structured form of play with or without a reward component. A game is a generic form or concept of a game that may be created specifically for the shopping feed 122 or modified from commonly understood examples for use on the shopping feed 122. Example games include price match, find me or find a product, contests, virtual races, time-based games, temporal based games (e.g., holidays, Independence day, Halloween, etc.), prized products games, hide and seek games, matching games, puzzles, word search, cross words, brain teasers, identification games, memory games, trivia, and/or any other common game type. The game may be performed singly or as part of a group or team. Some games may have a competition element where the user competes against other users or the game may be individually focused competition.

The games displayed to the user on the shopping feed may be specific to the user based on personalization features. The user specific games may be displayed in the gamification module 114 as well as throughout the shopping feed 122. In some instances, the products shown in a display area as well as those incorporated in the prompt, game, and/or rewards may be user specific based on personalization features and user interaction data as well. The user specific products may be a prized products list which is a subset of the products offered for sale on shopping feed 122. The products on the prized products list may be utilized as part of a standalone prized products game and/or utilized as highlighted products within other game options. The prized products may be identified on the shopping feed 122 with a prized product indicator 130 such as the trophy on the smart phone tile in display area 116.

As shown in FIG. 2, two game tiles are displayed in the gamification module 114, a “Price Guess” game tile 138 and a “Find Me” game tile 140. Each game tile may be selectable and interactive for the user. The game tile, if selected, may open a pop-up window, information box, or link to a different webpage with more information about the game. The game information may include rules of the game, how to play the game, a description of the game, time limits for play or to collect rewards, rewards information, a selectable feature to indicate the user intends to play the game, selectable recommendations of alternative games, and other similar information.

A reward tile, such as exemplary “Rewards” reward tile 142, may be included in the gamification module 114 and/or elsewhere on the shopping feed 122. The rewards tile 142 may be an interactive and/or selectable tile which provides reward information to the user. The reward tile, if selected, may open a pop-up window, information box, or link to a different webpage with more information about rewards. The reward information may include general reward information about available rewards and options for rewards redemptions as well as specific reward information pertaining to the user's account. Examples of general reward information include a leaderboard, available rewards, information about a reward type, options for utilizing a reward type, etc. In some embodiments the rewards tile may include options to apply rewards to items on the shopping feed 122.

A reward may be a thing given for completion of a task. The task may be associated with a game and/or some action taken on the shopping feed 122. The task may be relatively easy to accomplish such as a prompt offering a reward for clicking on any tile in a display area, such as display area 116. Conversely the task may be relatively complex such as completing a crossword game with prized products as the answers to the clues. Based on the variable nature of the tasks, the rewards may also be variable options corresponding to the complexity of the task. In such instances, clicking a tile may earn 10 reward points while completing a crossword puzzle may earn a 10% discount on a product in the crossword puzzle. In some instances, the user may be offered the opportunity to select a desired reward and task either before completion of the task or after completion of the task. Rewards may also be presented at various levels such that participating in more game tasks and/or more complicated game tasks would generate more lucrative or attractive rewards for the user. Conversely, participating in fewer or less complicated game tasks would generate less lucrative or attractive rewards for the user. Additionally, rewards may be bundled across one or more games such that the completion of the bundle of tasks would earn one or more highly prized rewards.

The reward may have extrinsic and/or intrinsic value to the user. A reward with extrinsic value may be a thing given to a user that has tangible value. Examples of an extrinsic reward may include money, discounts on a product, tokens, company and/or shopping feed rewards points, cashback options, exclusive sales, online coins, online currency, deposits in a bank account and/or other financial account associated with the user, reduction in fees and/or shipping costs associated with the purchase of a product, an actual product or service offered as a reward, and other things with tangible value. In one instance, a user may participate in a Price Match game with associated 25% off reward as shown by the “25% Off” prompt 128 in display area 116. If the user clicks the tile 128 and correctly identify the price of a product, they may receive the extrinsic reward of 25% off the “Martini Glass” product. Another example may be an extrinsic reward of shopping feed reward points that can be accumulated over time then redeemed in a variety of ways perhaps to obtain a product directly, as a cash back option, and/or as an alternative form of payment singularly or in combination with another form of payment.

A reward with intrinsic value may be a thing that provides intangible value. Examples of an intrinsic reward include emotional satisfaction, sense of achievement and/or pride in accomplishing a task, personal motivation, leaderboards or rankings available to the public for the user to display their accomplishments to other users, notifications within a larger user group that a user has accomplished something, learning something new, expanding competence in a particular area, and/or other things of intangible value to the user. In one instance, a user may be viewing display area 118 and see the prompt 134 with prompt “Click for 10 Leaderboard Points!”. The user may recognize that this is a prompt for an intrinsic reward of 10 points which will be applied to the user profile for recognition in a public leaderboard by clicking the tile and/or prompt 134. In some instances, the user may participate in a group that receives notifications when a member receives a reward. In this instance, an additional intrinsic reward of notification among peers for personal motivation may be received in addition to the leaderboard points.

In some instances, a reward may be a combination of options having both extrinsic and intrinsic value to the user. Examples of combination rewards include earning rewards that apply to a larger group of users as a collaborative effort, participating in a leaderboard contest where a certain number of top performers or teams receive an extrinsic reward at the end of a certain time period in addition to the leaderboard, a public trivia game where the users scores are publicly shown and the top performers receive a gift card for use on the shopping feed 122, etc. The varying levels of rewards, both extrinsic and intrinsic, benefits the user by providing optional levels of interaction with the shopping feed 122 while still receiving some profit from gamification.

As an example of a typical use scenario, if the “Price Guess” game tile 138 was selected by a user an information box may be presented which includes a description of the price guess game as a match the price to the product game, game time limits, the rewards available, and alternative games. The game may be specific to the user with one or more prized products from the prized products list based on user specific personalization features. The user may be asked to guess the price of a prized product with varying degrees of exactness that correspond to various levels of rewards such that an exact price guess would achieve the most valuable reward. By making the user specific prized product the subject of the game, the user is presented with an interesting product and an associated price which based on the additional reward may become very enticing to the user to purchase at that time or in the future.

Another example of typical use scenario is if the user selects the game tile 140 “Find Me” which may be a prized product game. In this prized product game, the gamification engine may produce a group of prized products based on personalization features specific to the user. The prized products may be populated throughout the shopping feed 122 with a prized product icon 130 in this case a trophy displayed on the topic or tile in a display area, such as the smart phone tile on display area 116. In some instances, the user may receive a prompt and/or hint within the prompt window 136 such as what is shown in FIG. 2 to initiate the search. In other instances, the user may not receive a prompt or hint but the one or more prized products indicators 130 may still be hidden throughout the shopping feed 122. Additionally, the user may receive a notification, prompt, and/or hint about the prized products on an application used on a computing and/or mobile device. The user may then search through the shopping feed to locate and interact with the prized product to receive the reward. In this instance, merely clicking on the prized product 130 “Smart Phone” may get a lower-level reward like 50 points, while clicking on ten prized products (not shown) within the shopping feed may get 500 points.

An additional example of a typical use scenario may be if the user clicks on prompt 132 “Trivia” in display area 116. Clicking prompt 132 may transition the user to a trivia game with an active leaderboard. The user may answer trivia questions about that product and/or other products where the number of correct answers is displayed on a leaderboard as the intrinsic reward. In some instances, there may also be a combination reward where the user receives leaderboard motivation coupled with gift card options for answering twenty or more trivia questions correctly with a tiered gift card approach as more correct answers are earned.

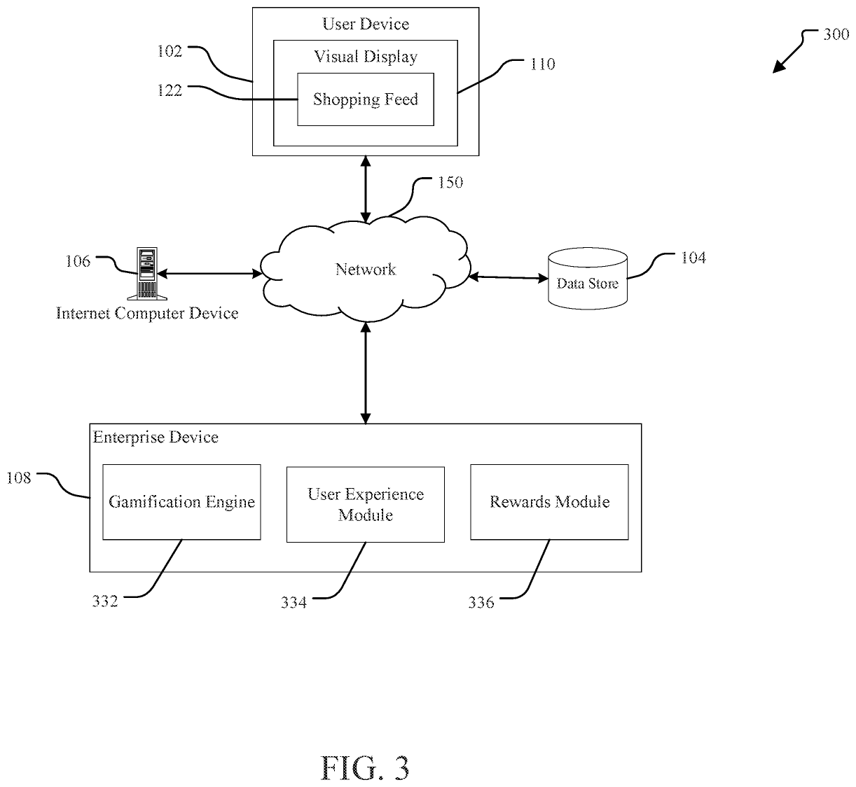

FIG. 3 is a diagram illustrating a system for providing a shopping feed with games and rewards, according to aspects described herein. As illustrated, system 300 comprises a user device 102, visual display 110, shopping feed 122, internet computer device 106, data store 104, enterprise device 108, and network 150. In examples, user device 102 and enterprise device 108 communicate via network 150, which may comprise a local area network, a wireless network, or the Internet, or any combination thereof, among other examples.

According to aspects described herein, when a user accesses a shopping feed 122 on a visual display 110, a background process communicates with enterprise device 108 to provide gamification of the shopping feed 122 for display to the user. User device 102 may be any device that can receive, process, modify, and communicate content on the network 150. Examples of a user device 102 include a desktop computer, laptop computer, tablet, and wireless device. In examples, the shopping feed 122 displays information and content for use on the user device 102 and for communication across the network 150. In instances, shopping feed 122 may include a search feature which enables the user to search for content stored on the shopping feed 122 or stored in a different database such as data store 104, a server, or an application (not pictured) via network 150. Shopping feed 122 may be a native application or a web-based application. Shopping feed 122 may operate substantially locally to user device 102 or may operate according to a server/client paradigm in conjunction with one or more servers (not pictured). In some instances, the shopping feed 122 and or enterprise device 108 may communicate one or more internet computer device 106 to complete requests. Data store 104 may contain information relating to the user profile associated with the user accessing the shopping feed 122.

Enterprise device 108 may access the user device 102 via the network 150. Enterprise device 108 may receive notification that a user has accessed the shopping feed 122 and receive a request to gamify the shopping feed 122 with one or more user specific games and rewards. Upon receiving the notification, enterprise device 108 may process the request and return a gamified shopping feed 122 for display on the visual display 110. Enterprise device 108 is illustrated as comprising gamification engine 332, user experience module 334, and rewards module 336.

The gamification engine 332, may gamify the shopping feed to include one or more games, prompts, products to use in a game, and/or prized products specifically for the user. Gamification may involve two levels of personalization for each user. As discussed previously, there are a plurality of games and game types which may be available for selection and personalization to the user. Game information may be stored on the enterprise device 108 or the game information may be stored on data store 104 and accessed by gamification engine 332 via the network 150. The gamification engine 332 may select one or more games for a user and then select products for the user to be displayed in the selected game and/or on the shopping feed 122. A prized product may be a subset of the products offered on the shopping feed 122 that may be highlighted to the user on the shopping feed 122, by use in a game, prompt, and/or as a reward. The gamification engine 332 may also generate one or more prompt for display on the shopping feed 122. The prompts may be generated once the games, game products, and/or prized products are generated such that the prompts are specifically related to those items

The gamification engine 332, upon receiving notification that a user is accessing the shopping feed 122, may identify personalization features for the user. The personalization features may be information related to the user profile, merchant preferences, and general shopping feed information. The personalization features may be utilized by the gamification engine 332 to generate user specific games, products, and rewards on the shopping feed 122. Information relating to the personalization features may be stored on the enterprise device 108, on the data store 104, and/or locally on the user device 102.

The user profile may be a collection information related to the user that may serve as a digital representation of the identity of the user on the shopping feed 122. Examples of information stored in a user profile include user setting choices, user selected preferences, activity history, rewards earned, earned reward status, user game statistics, game status, game completion, user game play history, user response to game and/or rewards recommendations, purchase history, return history, previously viewed products, time spent viewing a product, time spent between reward earned and reward utilized, reward preferences, user game preferences, personal information (address, date of birth, contact information, etc.) payment information, shipping preferences, account information, and/or other information associated with the user.

Merchant preferences may be information provided by the merchant to the shopping feed 122 developer relating to gamification, product information, marketing preferences, and/or other information a merchant may provide. Examples of merchant preferences include information provided by merchants offering products for sale on the shopping feed 122, relating to products to include in the prized products list, products to highlight, sales, discounts, alternative rewards options (cashback, points, accompanying products, etc.), marketing preferences, preferred games for their product, preferred rewards for their product, how to categorize their product, where to place their product, and other information that the merchant may provide.

General shopping feed information may be information generated and/or obtained on the shopping feed 122 or otherwise known to the shopping feed 122 developer. Examples of general shopping feed information may include global statistics for all users of the shopping feed 122 relating to total users game statistics, total times a game was played, game completion statistics, task completion statistics, product information, total user purchase preferences (e.g., method of payment, shipping method, product bundling, etc.), how often a product is viewed, product purchase statistics (e.g., product purchased at full price, product purchased at discount, etc.), total users rewards preferences, total user temporal preferences (e.g., which products, games, and rewards are preferred at certain times of year such as the holidays, Independence Day, Halloween, etc.), and/or other information known to the shopping feed 122 developer. The merchant preferences and general shopping feed information may be commonly applied to each user of the shopping feed 122 and/or it may be applied on a more granular level to specific regions, locations, groups, etc. to provide engaging games and rewards. Personalization features may be identified and updated for the specific user accessing the shopping feed 122 on a regular interval such as each time the user access the shopping feed 122, daily, weekly, and/or some other interval.

A variety of strategies may be utilized by the gamification engine 332 to determine the prized products, games offered, and game products to be included on the shopping feed 122. One strategy may be based on a machine learning model. In this instance, the gamification engine 332 may apply the data associated with the personalization features and user interaction data to a machine learning model to predict which games, rewards, and products should be presented to the user. The model may be trained and evaluated in either a supervised and/or unsupervised fashion using a variety of online and offline evaluation metrics to improve model prediction accuracy. Over time the user interaction data collected on games played, games ignored, prompt interaction, rewards selected, rewards ignored, past purchases, etc. from the individual user as well as other users of shopping feed 122 in combination with the personalization features may be introduced to the model to train it on what is preferred by each user and globally on the shopping feed 122.

A second strategy may be a random assignment of games, prized products, and game products. The random assignment could be utilized if the user profile is not set up, if the user is a guest on the shopping feed 122, because the user has not interacted with the shopping feed often enough to generate user interaction data or personalization features for a more exact strategy, because the user selected random as the game assignment method, and/or based on a design choice by the shopping feed 122 developer. In such an instance, the gamification engine 332 may utilize the merchant preferences and general shopping feed information to determine the games, prized products, and products to be included in a game. In such an instance, the merchant may be given the option to design the game play, game offerings, prized products list, products included in a game, and rewards offered on the shopping feed 122.

A third strategy may be a machine learning model based just on a subset of the personalization features individually and/or in combination with the user interaction data. In this instance the input for the machine learning model may be one or more of the user profiles, merchant preferences, and/or general shopping feed information. For example, if merchant preferences was singly input to the machine learning model a merchant would be given the opportunity to directly select which games are displayed, the products on the prized products list, and game products. In this strategy the merchant may be able to selectively highlight certain products and pair them with game types that pair well with the product. The merchant may highlight certain desired products by making them prized products on the prized products list. Alternatively, if the user profile was the sole input to the machine learning model the games, products, and rewards displayed to the user by gamification engine 332 would be specific to the user. In some instances, a combination subset of personalization features may be applied.

A fourth strategy may be a moment in time strategy where the gamification engine 332 prioritizes the temporal moment to gamify the shopping feed 122. In this instance, temporal factors such as time, user location, date, holidays, important cultural events, and other events that are temporally important would be prioritized. For example, if the user was in the United States, and the Super Bowl is in the next week, the games, products, prized products, and rewards may be directed towards the temporal event of the Super Bowl. In such an instance, the game selected might be a price guess game with products from a prized products list relating to a super bowl watch party.

The user experience module 334 may generate the shopping feed 122 for display on the visual display 110. The output of the gamification engine 332 may be an application programming interface that is provided to the user experience module 334. The user experience module 334 may utilize the output to populate the shopping feed 122 with the prompts, games, and rewards in the gamification module (e.g., gamification module 114) and note prized products on the various tiles and topics. Additionally, the user experience module 334, may link the user to selected games, display additional information, and track user interaction with the shopping feed 122 as user interaction data.

User interaction data may be data associated with the user's current session on the shopping feed 122. Generally, user interaction data may include what the user selects on the shopping feed 122, current game status, time spent playing a game, game task completion, rewards earned, earned reward status, applied rewards, products the user has viewed, product purchases, product returns, the user's location when accessing the shopping feed 122, the user's method of accessing the shopping feed 122, temporal information about when the user accesses the shopping feed 122, game settings that the user prefers (sound on or off, in-game hints, etc.), accessing more information about a game, reward, game product, and/or prized product, and/or any other interaction with a game, product, reward, prized product and/or the shopping feed 122. For example, user interaction data would be captured if the user accesses the shopping feed 122 and looks at a category of products in a visual display area (e.g., visual display area 116). User interaction data will be recorded for user interactions even if the interaction is not directly related to gamification.

In some instances, user interaction data may be further categorized into correct and incorrect user interaction data. Correct user interaction data may be an action taken by a user who is participating in a game that completes a task in the game. For example, if the user is participating in a trivia game and answers a trivia question correctly, the correct action may be recorded as correct user interaction data. The correct action does not necessarily earn the user a reward, but it may be recorded as part of the requirements to earn a reward. Continuing the trivia example, if the user needs to answer ten trivia questions correctly, the first nine questions answered correctly might be recorded as correct user interaction data, but the tenth correct answer would earn the reward. In such a situation, the first nine questions might be recorded as game status information in the user profile and the tenth correct answer would be recorded as an earned reward. Conversely, incorrect user interaction data may be an action taken by a user who is participating in a game that does not complete a task in a game. For example, if the user is participating in a trivia game and gets a question wrong, incorrect user interaction data may be generated and updated on the user profile. In some embodiments, the user may also receive a notification that the user action was either correct or incorrect.

In embodiments, the personalization features may be modified based on user interaction data, such as updating the user profile with user interaction data relating to game status, rewards earned, etc. The user experience module 334 may communicate with both the gamification engine 332 and rewards module 336 on user interaction with the shopping feed 122 and provide user interaction data. A separate application programming interface may be utilized for the user experience module 334 to update the rewards module 336 and gamification engine 332 with user interaction data.

The rewards module 336 may determine the rewards to be offered to the user and maintain a rewards account on the user profile. The rewards module 336 may receive information from the gamification engine 332 on the selected game, game products, prized products and prompts then determine the rewards to be associated with them. The rewards module 336 may determine the reward using a machine learning model where personalization features and user interaction data are the input to predict the appropriate reward. The rewards module 336 may also receive notification of user interaction with the shopping feed 122 and associated user interaction data from the user experience module 334 and update the user rewards account accordingly. The rewards module 336 may also maintain status and updates for intrinsic rewards offered to all users such as leaderboard position, group rankings, etc. The rewards module 336 may pass the rewards information to the user experience module 334 for presentation to the user on the shopping feed 122.

As will be appreciated, the various methods, devices, apps, nodes, features, etc., described with respect to FIG. 3 or any of the figures described herein, are not intended to limit the system to being performed by the applications and features described. Accordingly, additional configurations may be used to practice the methods and systems herein and/or features and apps described may be excluded without departing from the methods and systems disclosed herein.

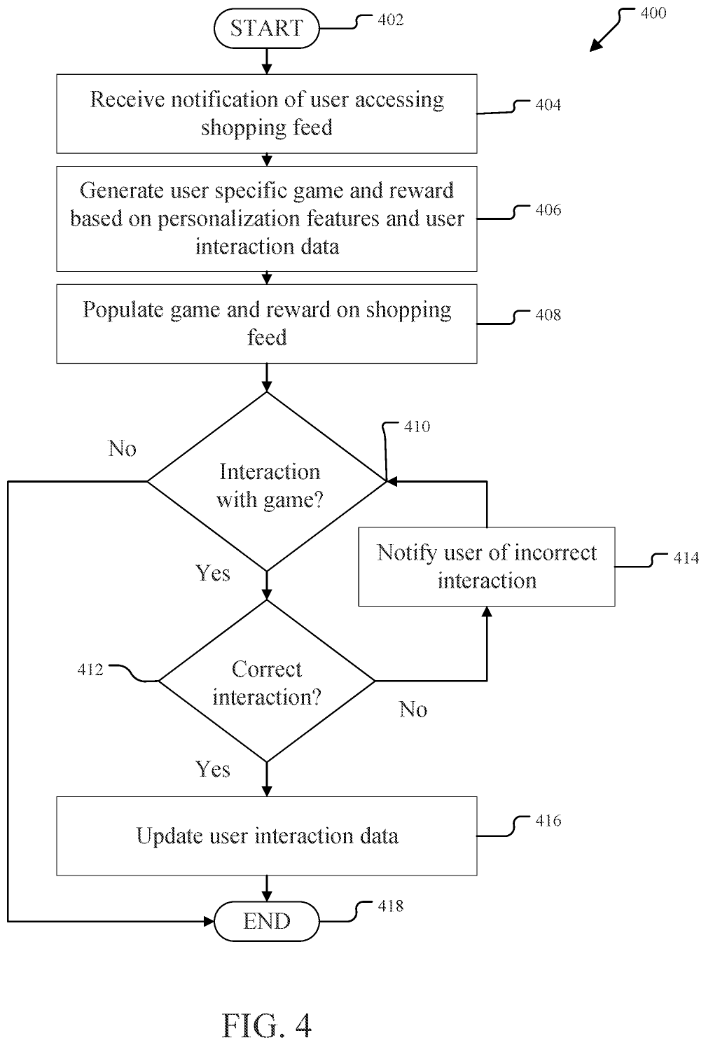

FIG. 4 is a block diagram illustrating a method for presenting a shopping feed with games and rewards for user interaction, according to aspects described herein. A general order of the operations for the method 400 is shown in FIG. 4. Generally, the method 400 begins with start operation 402 and ends with end operation 418. The method 400 may include more or fewer steps or may arrange the order of the steps differently than those shown in FIG. 4. The method 400 can be executed as computer-executable instructions executed by a computer system and encoded or stored on a computer readable medium. Further, the method 400 can be performed by gates or circuits associated with a processor, an ASIC, an FPGA, a SOC or other hardware device. Hereinafter, the method 400 shall be explained with reference to the systems, components, devices, modules, software, data structures, data characteristic representations, signaling diagrams, methods, etc., described in conjunction with FIGS. 1, 2, 3, 5, 6, 7, and 8.

Following the start operation 402, the method 400 begins with the receive operation 404, where notification of a user accessing the website and/or shopping feed is received. The notification of the user accessing the shopping feed (e.g., shopping feed 122) may be received from the shopping feed by a user experience module 334 and transmitted to a gamification engine (e.g., gamification engine 332) and/or a rewards module (e.g., rewards module 336). The notification may initiate the gamification process for the shopping feed.

Flow progresses to generate operation 406, where a user specific game and reward are generated for the user based on personalization features and user interaction data. A gamification engine (e.g., gamification engine 332) may utilize personalization features and user interaction data applied to a machine learning model in a variety of strategies to identify the games, game products, prized products, and prompts for a specific user. The output of the gamification engine may be passed to a rewards module (e.g., rewards module 336). The rewards module may access the personalization features and user interaction data as input to a machine learning model in conjunction with the output from the gamification engine to identify what reward types to pair with the games for the user specifically.

Flow progresses to populate operation 408, where the shopping feed (e.g., shopping feed 122) is populated with the game and reward. A user experience module (e.g., user experience module 334) may take the output of the gamification engine (e.g., gamification engine 332) and the rewards module (e.g., rewards module 336) and populate it on the shopping feed. A game, prized product, and/or a reward may be presented to the user in a gamification module (e.g., gamification module 114), on tiles and/or topics on a visual display area (e.g., visual display areas 112, 116, and 118), and/or elsewhere on the shopping feed such as the user profile page, pop-up windows, linked pages, etc. as described herein.

Flow progresses to decision operation 410, which asks if the user has interacted with the game? User interaction with the game may be in a variety of ways including selecting a game tile, reward tile, prompt, and/or prized product in addition to other means of interaction described herein. User interaction may be recorded as user interaction data. If the user has not interacted with a game, flow progresses to end operation 418.

If the user does interact with a game flow progresses to decision operation 412 which asks if the user has made a correct interaction with the game. A correct user interaction may be an action taken by a user who is participating in a game that completes a task in the game. For example, a correct interaction would be completion of a task associated with a game, such as correctly identifying the price of a product in a price match game. Conversely, an incorrect user interaction may be an action taken by a user who is participating in a game that does not complete a task in the game. For example, an incorrect interaction may be an action taken by the user which does not result in the completion of a game, such as selection of a product that is not a prized product. User interaction on the shopping feed may be monitored and user interaction data may be recorded by a user experience module (e.g., user experience module 334).

If the user makes an incorrect interaction flow progresses to notify operation 414, where the user is notified that an incorrect interaction has been taken. The user may be notified by a user experience module (e.g., user experience module 334) via a pop-up window, prompt, banner, in-game message, and/or other message on the shopping feed (e.g., shopping feed 122) that the action taken was incorrect. Following the notification, the user experience module may update the user profile with user interaction data for the incorrect response. Flow progresses to operation 410 where the user experience module continues to monitor the shopping feed for subsequent user interaction.

If the user makes a correct interaction, flow progresses to update operation 416, where the user interaction data is updated. The user experience module (e.g., user experience module 334) may identify a correct interaction by the user. In some instances, the correct interaction may be completing a game task and earning a reward. In this case, the user experience module may update the rewards module (e.g., rewards module 336) with user interaction data for the correct interaction and the appropriate reward may be applied to the user profile. In another instance, the user may select a game to play from one or more game options, the selection may be transmitted to a data store (e.g., data store 104) to update the user profile with the game preference. The method ends with end operation 418. That said, one skilled in the art will appreciate that once a game is completed and the user interaction data is updated, e.g., at update operation 416, then flow may branch back to populate operation 408 wherein the same game and/or other games may be presented to the user for more gameplay. Such additional gameplay increases the amount of time a user in interacting with the given web site.

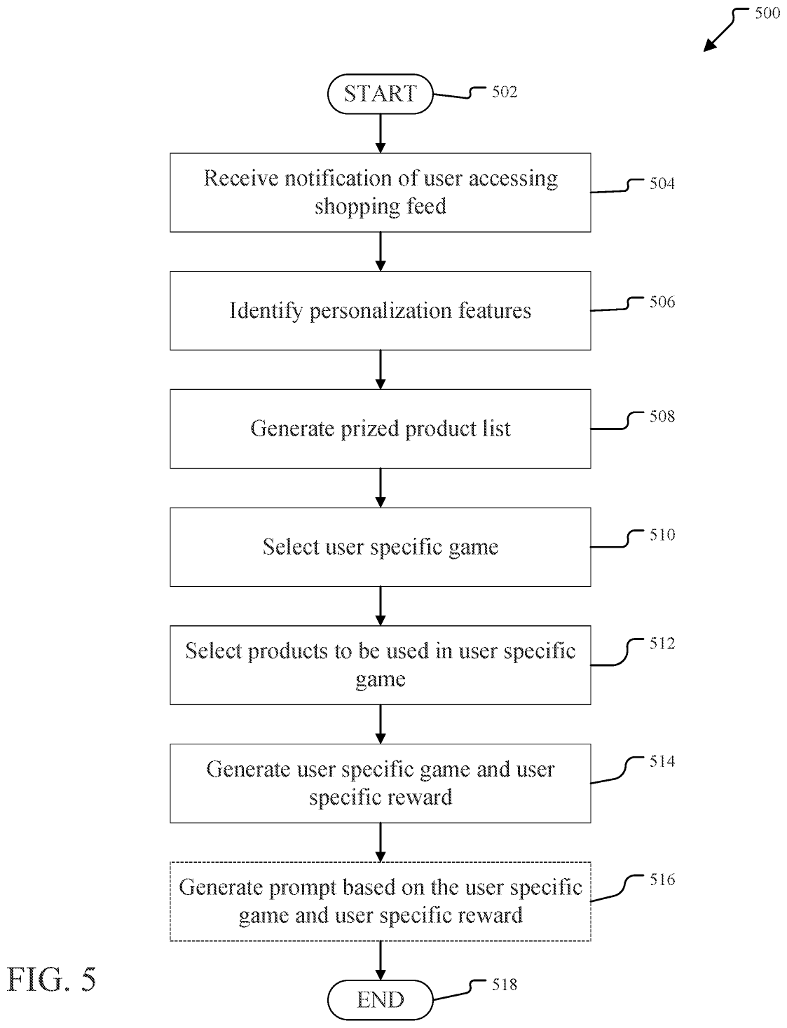

FIG. 5 is a block diagram illustrating a method for generating a user specific game and reward, according to aspects described herein. A general order of the operations for the method 500 is shown in FIG. 5. Generally, the method 500 begins with start operation 502 and ends with end operation 518. The method 500 may include more or fewer steps or may arrange the order of the steps differently than those shown in FIG. 5. The method 500 can be executed as computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1, 2, 3, 4, 6, 7, and 8.

Following the start operation 502, the method 500 begins with the receive operation 504, where notification of a use accessing the shopping feed is received. The notification of the user accessing the shopping feed (e.g., shopping feed 122) may be received from the shopping feed by a user experience module 334 and transmitted to a gamification engine (e.g., gamification engine 332) and/or a rewards module (e.g., rewards module 336). The notification may initiate the gamification process for the shopping feed.

Flow progresses to identify operation 506, where personalization features are identified. Personalization features may include information related to the user profile, merchant preferences, and/or general shopping feed information. The user profile may be information specific to the user whereas the merchant preferences may be defined by the merchant and generally applicable to multiple users on the shopping feed (e.g., shopping feed 122). Similarly, the general shopping feed information may be generally applicable to multiple users on the shopping feed. A gamification engine (e.g., gamification engine 332) may access a data store (e.g., data store 104) to access the personalization features information.

Flow progresses to generate operation 508, where the prized product list may be generated based on the personalization features and user interaction data. The gamification engine (e.g., gamification engine 332) may generate a prized products list as a subset of the products available on the shopping feed (e.g., shopping feed 122). The prized products list may be based off the personalization features and user interaction data to include products that may be highly engaging to the user.

Flow progresses to select operation 510, where one or more user specific games are selected for the user. The gamification engine (e.g., gamification engine 332) may apply the personalization features and user interaction data to a machine learning model designed using a variety of strategies to select one or more games for the user from the plurality of game options. The games may be selected to be engaging to the user based on the personalization features and user interaction data.

Flow progresses to select operation 512, where one or more products are selected for use in the user specific game. The gamification engine (e.g., gamification engine 332) after it selects the game for the user, matches products for use in the game. The products may be selected from the prized products list, based on merchant preferences, and/or from the products available on the shopping feed (e.g., shopping feed 122) that are effective for the game selected.

Flow progresses to generate operation 514, where the user specific game and user specific reward are generated. Once the game and game product are selected the information is passed to a rewards module (e.g., rewards module 336) where the personalization features and user interaction data is utilized to generate an appropriate reward and/or levels of rewards for the game. The personalization features and user interaction data may be used as input to a machine learning model to generate the appropriate reward.

Flow progresses to generate operation 516, where a prompt based on the user specific game and user specific reward is generated. Operation 516 is shown as a dashed box to indicate that it is an optional step. The user specific game and the reward output from the rewards module (e.g., rewards module 336) may be sent back to the gamification engine (e.g., gamification engine 332) which may generate a prompt for the game and/or reward. The prompt may be directed at one or more aspects of the game, the reward, a certain task and/or product within the game, etc. The method ends with end operation 518.

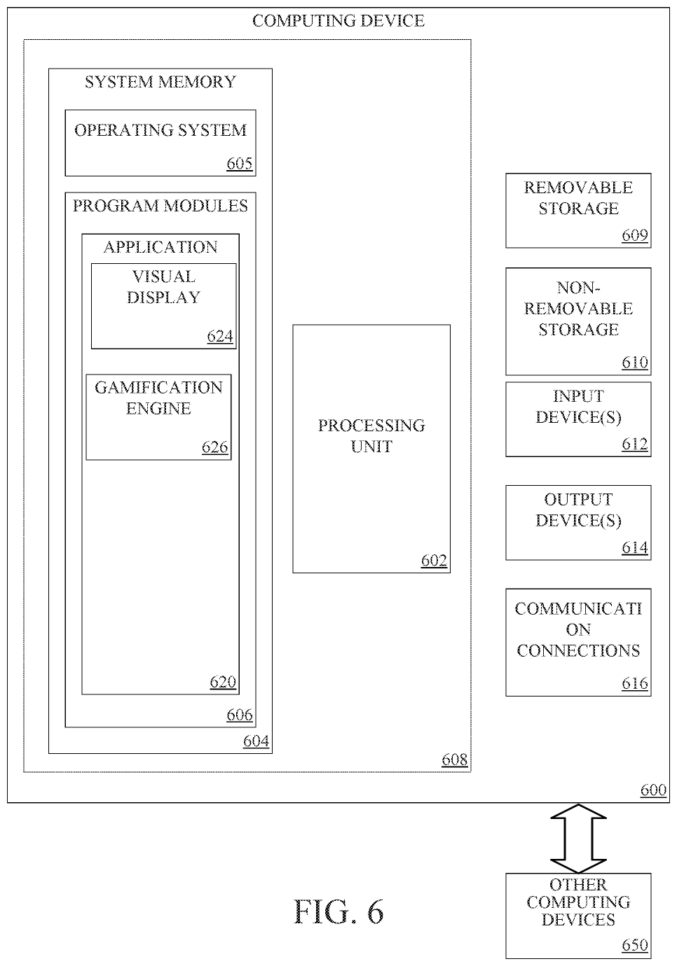

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including user device 102, as well as one or more devices associated with enterprise device 108. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store visual display 624 and gamification engine 626. The operating system 605, for example, may be suitable for controlling the operation of the computing device 600.

Furthermore, embodiments of the disclosure may be practiced in conjunction with a graphics library, other operating systems, or any other application program and is not limited to any application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, several program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

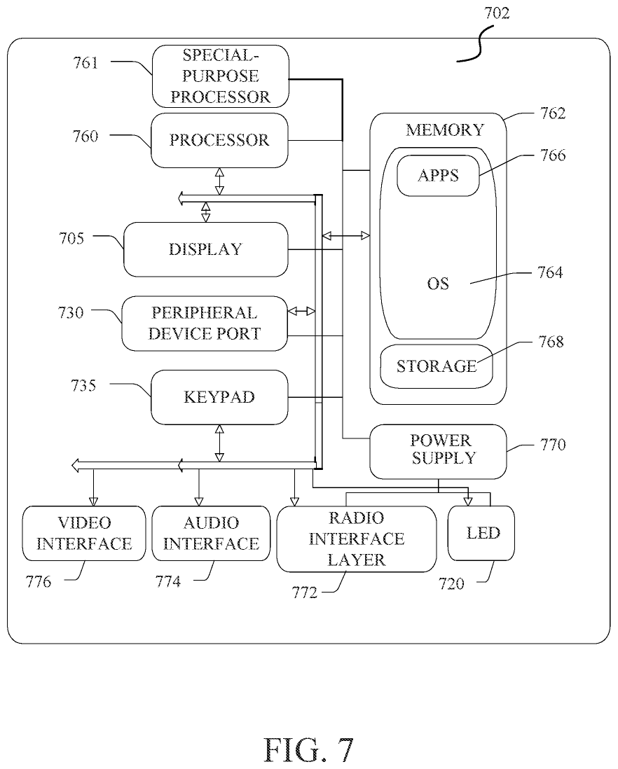

FIG. 7 is a block diagram illustrating the architecture of one aspect of a computing device 700 (not shown) for example, a mobile telephone, a smart phone, wearable computer (such as a smart watch), a tablet computer, a laptop computer, and the like, with which embodiments of the disclosure may be practiced. In some aspects, the client may be a mobile computing device. That is, the computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 1068 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the computing device 700 and stored via the system 702 may be stored locally on the computing device 700, as described above, or the data may be stored on any number of storage media that may be accessed by the device via the radio interface layer 772 or via a wired connection between the mobile computing device 700 and a separate computing device associated with the computing device 700, for example, a server computer in a distributed computing network, such as the Internet. As should be appreciated such data/information may be accessed via the computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

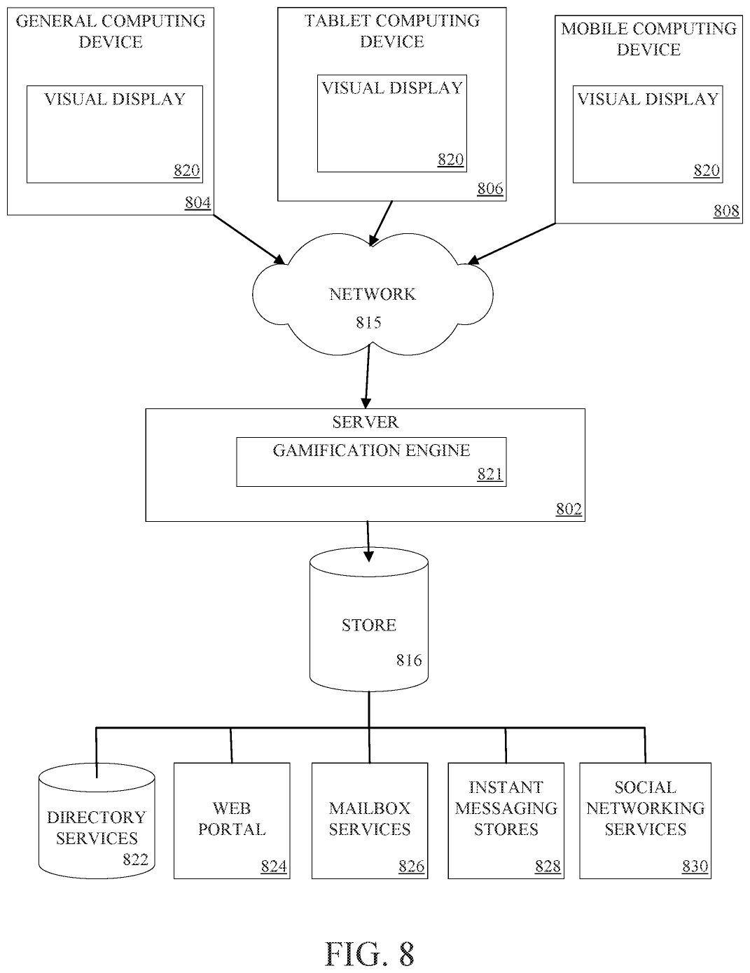

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 822, a web portal 824, a mailbox service 826, an instant messaging store 828, or a social networking site 830.

A visual display 820 may be employed by a client that communicates with server device 802, and/or gamification engine 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these embodiments of the computing devices may obtain content from the store 816, in addition to receiving graphical data useable to be either pre-processed at a graphic-originating system, or post-processed at a receiving computing system.

Over time, the popularity of online shopping has grown such that the volume of goods and services offered may overwhelm a consumer. This creates a problem where users do not fully engage with the offerings on the shopping feed. In some instances, the user may narrow their interaction to preferred categories rather than browsing the shopping feed. In the worst case, a user may disregard the shopping feed completely and search for an intended product directly. Additionally, users may choose not to interact with the shopping feed on a regular basis, instead utilizing the platform on an as needed basis to search for a specific product or product type. In each instance, the user is not receiving the full diversity of offerings available on the shopping feed, and sellers may not be able to present their products to the desired volume of users.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system comprising:
at least one processor; and
memory storing instructions that, when executed by the at least one processor, causes the system to perform a set of operations, the set of operations comprising:
receiving notification of a user accessing a shopping feed, wherein the shopping feed is an interactive marketplace displaying a plurality of products for sale;
generating a user specific game from a plurality of games based on one or more user personalization features and a user interaction data, wherein the user specific game includes one or more products selected from the shopping feed;
generating a user specific reward;
populating the user specific game and the user specific reward on the shopping feed;
determining user interaction with the user specific game; and
updating the user interaction data related to the user specific game.

2. The system of claim 1, wherein generating the user specific game further comprises:
generating a prompt based on the user specific game; and
populating the prompt on the shopping feed.

3. The system of claim 1, wherein generating the user specific reward further comprises:
generating a prompt based on the user specific reward; and
populating the prompt on the shopping feed.

4. The system of claim 1, wherein updating user interaction data further comprises:
determining a correct user interaction with the user specific game; and
updating the correct user interaction on a user profile.

5. The system of claim 4, wherein updating the correct user interaction on a user profile further comprises:
applying a reward on the user profile.

6. The system of claim 1, wherein updating user interaction data further comprises:
determining an incorrect user interaction with the user specific game; and
updating the incorrect user interaction on a user profile.

7. The system of claim 6, wherein determining an incorrect user interaction further comprises:
notifying the user of an incorrect user interaction.

8. The system of claim 1, wherein a reward further comprises an extrinsic reward, an intrinsic reward, or a combination of both an extrinsic reward and an intrinsic reward.

9. A method comprising:
receiving notification of a user accessing a shopping feed, wherein the shopping feed is an interactive marketplace displaying a plurality of products for sale;
generating a user specific game from a plurality of games based on one or more user personalization features and a user interaction data, wherein the user specific game includes one or more products selected from the shopping feed;
generating a user specific reward;
populating the user specific game and the user specific reward on the shopping feed;
determining user interaction with the user specific game; and
updating the user interaction data related to the user specific game.

10. The method of claim 9, wherein generating the user specific game further comprises:
generating a prompt based on the user specific game; and
populating the prompt on the shopping feed.

11. The method of claim 9, wherein generating the user specific reward further comprises:
generating a prompt based on the user specific reward; and
populating the prompt on the shopping feed.

12. The method of claim 9, wherein updating user interaction data further comprises:
determining a correct user interaction with the user specific game; and
updating the correct user interaction on a user profile.

13. The method of claim 12, wherein updating the correct user interaction on a user profile further comprises:
applying a reward on the user profile.

14. The method of claim 9, wherein updating user interaction data further comprises:
determining an incorrect user interaction with the user specific game; and
updating the incorrect user interaction on a user profile.

15. The method of claim 14, wherein determining an incorrect user interaction further comprises:
notifying the user of an incorrect user interaction.

16. The method of claim 9, wherein a reward further comprises an extrinsic reward, an intrinsic reward, or a combination of both an extrinsic reward and an intrinsic reward.

17. A method comprising:
receiving notification of a user accessing a shopping feed, wherein the shopping feed is an interactive marketplace displaying a plurality of products for sale;
identifying one or more user personalization features;
generating a prized product list, wherein the prized products list is a subset of the products offered for sale on the shopping feed;
selecting a user specific game from a plurality of games based on the user personalization features and a user interaction data;
selecting one or more products from the prized products list for use in the user specific game;
generating the user specific game and a user specific reward; and
populating the user specific game and the user specific reward on the shopping feed.

18. The method of claim 17, wherein generating the user specific game further comprises:
generating a prompt based on the user specific game.

19. The method of claim 17, wherein generating the user specific reward further comprises:
generating a prompt based on the user specific reward.

20. The method of claim 17, wherein a reward further comprises an extrinsic reward, an intrinsic reward, or a combination of both an extrinsic reward and an intrinsic reward.
